(19) United States
(12) Patent Application Publication
(10) Pub. No.: US 2021/0148481 A1
(43) Pub. Date: May 20, 2021

(54) MODULAR VALVE BODY WITH BIMETALLIC OPTION

(71) Applicant: Xomox Corporation, Cincinnati, OH (US)

(72) Inventors: Pete LYLE, Cincinnati, OH (US); Chris ALMOND, Cincinnati, OH (US); Sudhir KULKARNI, Cincinnati, OH (US)

(21) Appl. No.: 17/090,422

(22) Filed: Nov. 5, 2020

Related U.S. Application Data
(60) Provisional application No. 62/937,869, filed on Nov. 20, 2019.

(51) Int. Cl. F16K 27/10; B23K 20/12

(52) U.S. Cl. CPC F16K 27/10; B23K 2103/26; B23K 20/129

(57) ABSTRACT

A modular valve body with a bimetallic option is shown and described herein. The modular valve body generally includes at least one end connector element joined to a housing. The housing may be formed from a first material, such as carbon steel. The end connector element may be formed from a second material, such as monel. In some versions of the modular valve body, in order to join the end connector element and the housing, the end connector element is rotated and pressed against the housing to heat both materials and create a friction weld therebetween.

### BACKGROUND

Some valves include a main body for coupling with a valve assembly. The valve body may include a housing and at least one end connector element extending from the housing. The end connector element is used to secure a pipeline or similar feature to the valve via welding or fasteners. Pipelines are typically steel and given the ease of creating a carbon/carbon joint via welding, end connector elements are also typically steel. Conversely, given that iron fluoride build-up within a valve is undesirable, it is beneficial for the housing to be a non-steel material such as monel, which prevents iron fluoride build up. A problem exists in that, an entirely monolithic monel valve would not allow for a carbon to carbon joint between the end connector element and pipeline; and an entirely monolithic carbon steel valve would not prevent iron fluoride build up.

Some versions of the valve described in the present disclosure comprise a center body section joined to a desired end connector, whether via a butt weld, a screw style connection, or a flanged connection. The materials of construction may be similar for all pieces or dissimilar as required for special applications to facilitate ease of installation and enhanced corrosion properties. Valves welded to pipework can be repaired if they are top entry; however, a top entry cartridge design that can be repaired with simple tools using a pretested factory replacement cartridge has a significant impact on the total cost of ownership by reducing unplanned down time or planned maintenance turnaround programs.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 depicts a perspective view of an exemplary modular valve body with bimetallic option;

FIG. 2 depicts an exploded perspective view of the modular valve body of FIG. 1 with an exemplary pair of end connector elements spaced apart from an exemplary housing, whereby the housing and each end connector may be formed in a similar material or may be formed of dissimilar materials;

FIG. 3 depicts a cross-sectional view of the modular valve body of FIG. 2 taken along line 3-3;

FIG. 4 depicts a cross-sectional view similar to FIG. 3, with the end connector element friction welded to the housing;

FIG. 5 depicts a perspective view of another exemplary modular valve body with the end connector element having an exemplary connector flange;

FIG. 6 depicts a flowchart of an exemplary method of forming a modular valve body by forming a housing using a first material and forming an end connector using a second material, whereby the first material and second material may be similar or different; and

FIG. 7 depicts another flowchart of an exemplary method of forming a modular valve body with bimetallic option.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

It will be appreciated that any one or more of the teachings, expressions, versions, examples, etc. described herein may be combined with any one or more of the other teachings, expressions, versions, examples, etc. that are described herein. The following-described teachings, expressions, versions, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

I. Exemplary Modular Valve Body

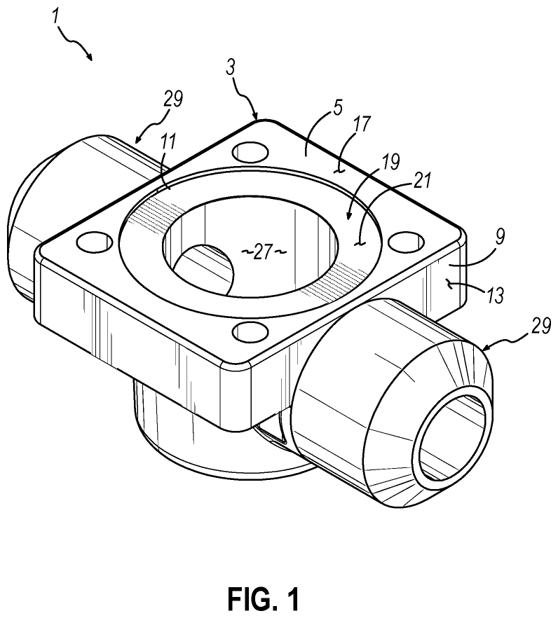

A modular valve body with bimetallic option is shown in FIG. 1, hereinafter referred to as modular valve body (1). As used herein, the phrase “bimetallic option” denotes how elements or features of modular valve body (1) may be comprised of similar materials or optionally may be comprised different materials. Modular valve body (1) may also be referred to as a hybrid valve given the two different materials used in its construction in some versions. Modular valve body (1) may be configured to receive a valve assembly (not shown) or otherwise incorporate elements to utilize modular valve body (1) in a valve structure. In some versions of modular valve body (1), a plug valve style of valve may be incorporated into modular valve body (1).

As will be discussed in greater detail below, the modularity of modular valve body (1) is realized by providing separate elements that may selected and joined as desired for a particular environment. Rather than a monolithic valve body structure, separating the elements such as the housing and end connectors allows for these elements to be created using different materials as desired, different methods of forming as desired, and different sizes/shapes as needed for a particular environment.

A. Exemplary Housing

Modular valve body (1) includes a housing (3). Housing (3) may be comprised of a first material. In some versions of modular valve body (1), the first material is a nickel alloy. In some versions of modular valve body (1), the nickel alloy may be monel.

Monel is a group of nickel alloys, primarily composed of nickel and copper, with small amounts of iron, manganese, carbon, and silicon. Stronger than pure nickel, monel alloys (referred to hereinafter as “monel”) are resistant to corrosion by many agents, including rapidly flowing seawater. Monel also has the benefit that it prevents iron fluoride build up within housing (3). In some versions of modular valve body (1), housing (3) is forged, rather than cast. In those versions, the forgings perform better compared to castings due to the homogeneity of microstructure that improves performance against inter granular corrosion. In yet other version of modular valve body (1), housing is bar stock machined.

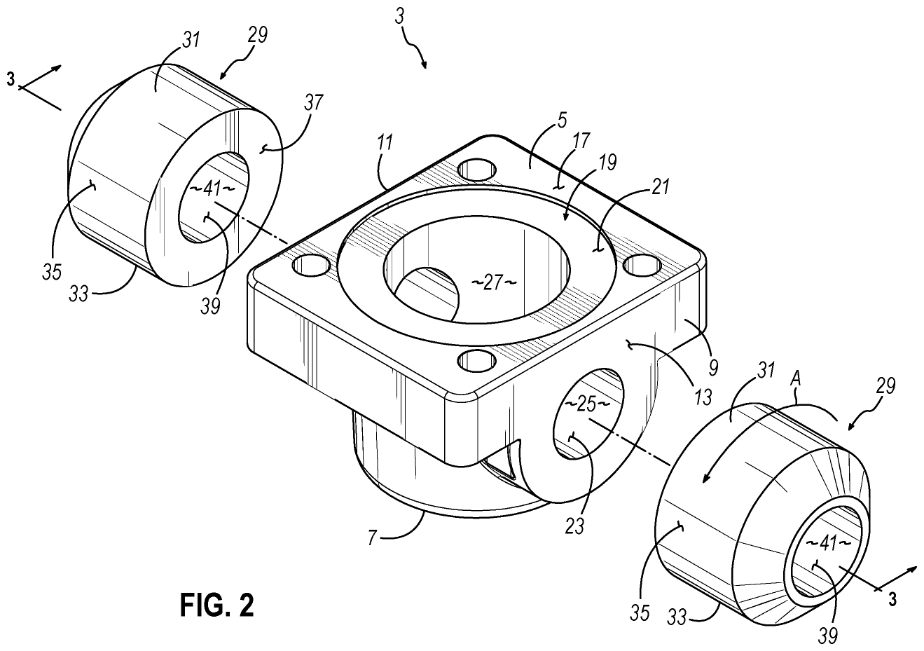

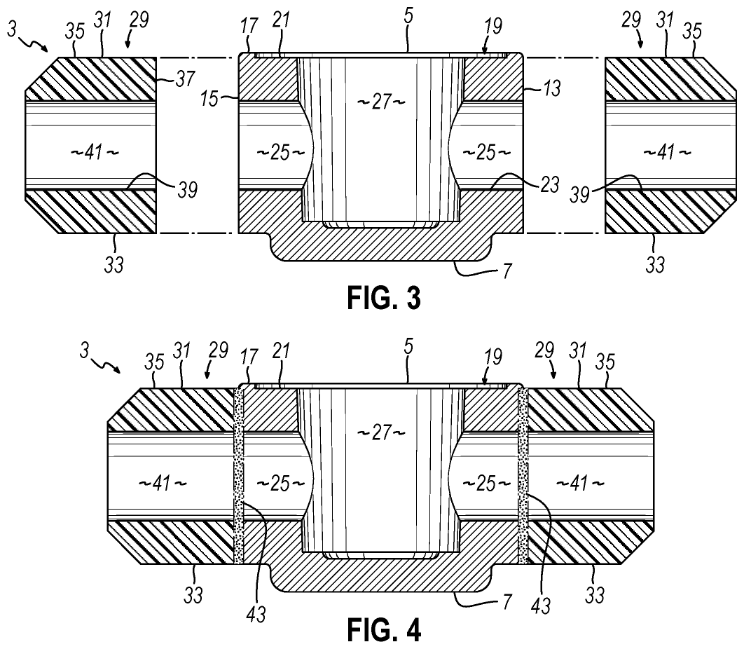

As shown in FIGS. 2 and 3, housing (3) includes a top (5) and a bottom (7), as well as a first side (9) and a spaced apart second side (11). First side (9) of housing (3) includes a first external surface (13). Similarly, second side (11) of housing (3) includes a second external surface (15), as shown in FIG. 3. Top (5) includes a top surface (17). A recess (19) is defined in top surface (17) and sized and positioned to selectively receive a portion of a valve assembly in furtherance of forming a working valve utilizing modular valve body (1).

As shown in FIGS. 3 and 4, housing (3) includes an internal housing surface (23). Internal housing surface (23) defines a housing flow passage (25) to facilitate the flow of fluid through housing (3). Some versions of internal housing surface (23) are smooth and free of any threads or grooves. Often in other valve bodies, grooves or threads for receiving connector elements are disposed on the interior surface and may disrupt the flow of fluid through the valve. Internal housing surface (23) may further define an internal chamber (27) sized to receive a portion of a valve assembly therein, in furtherance of forming a working valve utilizing modular valve body (1).

B. Exemplary End Connector Element

As shown in FIGS. 1-4, modular valve body (1) includes at least one end connector element (29). When modular valve body (1) is fully assembled, end connector element (29) extends from housing (3). End connector element (29) may be comprised of a second material. End connector element (29) may be forged, cast, or bar stock machined. In some versions of modular valve body (1), the second material is a steel material. In some versions of modular valve body (1), the steel material is carbon steel. In other versions of modular valve body (1), the first material used to form housing (3) and the second material used to form end connector element (29) are the same material.

End connector element (29) is generally cylindrical and extends from a top (31) to a bottom (33) and includes a peripheral surface (35) and an external surface (37). End connector element (29) includes an internal end surface (39). Internal end surface (39) defines an end flow passage (41) to facilitate the flow of fluid through end connector element (29). Some versions of internal end surface (39) are smooth and free of any threads or grooves. When joined with housing (3), end flow passage (41) is in fluid communication with housing flow passage (25).

End connector element (29) is configured to be joined with a pipeline to secure the pipeline to modular valve body (1). Inasmuch as pipelines in Hydrofluoric acid applications are often carbon steel, joining carbon steel pipelines to carbon steel end connector element (29) allows for a carbon to carbon joint. In monolithic valve bodies, the end connector element is formed from the same material as the housing. For example, a monel end connector would extend from a monel housing and the resulting weldment with a carbon steel pipeline would result in a monel to carbon joint. In a monel to carbon joint, a nickel butter pass to the carbon steel must be used prior to weld, resulting in increased time and complexity to produce an inferior joint. This is particularly inefficient when the pipeline is connected to the valve body on-site, which is often the case. Conversely, modular valve body (1) provides end connector element (29) in a material that complements the material of the carbon steel pipelines and allows for more efficient on-site weld.

C. Exemplary Friction Weld

As shown in FIGS. 3 and 4, housing (3) and end connector element (5) are joined together to form modular valve body (1). In some versions of modular valve body (1), end connector element (5) is joined to housing (3) by inertial friction welding end connector element (5) onto housing.

Friction welding is a solid-state welding process that generates heat through mechanical friction between workpieces in relative motion to one another to fuse the materials. Because no melting occurs, friction welding is not a fusion welding process in the traditional sense, but more of a forge welding technique. The advantages of friction welding are numerous. The combination of fast joining times (on the order of a few seconds) and direct heat input at the weld interface yields relatively small heat-affected zones. Friction welding techniques are generally melt-free, which mitigates grain growth in engineered materials such as high-strength heat-treated steels. Another advantage is that the motion tends to clean the surface between the materials being welded, which means they can be joined with less preparation. During the welding process, depending on the method being used, small pieces of the plastic or metal will be forced out of the working mass (flash). The flash carries away debris and dirt.

In the present scenario, housing (3) is held generally stable in a non-rotating chuck or similar device (not shown), while end connector element (5) is rotated axially at a high rate of speed in a flywheel chuck or similar device (not shown), in the direction of Arrow A (FIG. 3). Once the flywheel has reached the predetermined speed, housing (3) and end connector element (5) are pushed together to cause extreme friction. The friction and resulting heat soften the materials of both housing (3) and end connector element (5), but do not liquify the materials. Instead, portions of both housing (3) and end connector element (5) are in a plasticized state and are soft and malleable. Molecules from both housing (3) and end connector element (5) flow evenly into each other, creating a full cross-sectional bond. This cross-sectional bond is a friction weld (43) between housing (3) and end connector element (5).

Friction weld (43) provides many advantages over traditional welds. Friction weld (43) lowers material, tooling, research and development, and machining costs. Further, the high-speed process translates to high production rates with larger quantity orders and a higher speed to market for modular valve body (1). Still further, the joint strength is equal or greater to that of the parent metals and the integrity of friction weld (43) is very reliable, with resulting joints able to withstand high temperatures.

While frictional welding may weld dissimilar metals where traditional welding could not, different types of materials have different qualities that give the materials various heat tolerances, strength, and other features. An effective amount of rotational speed and force needed in the lateral thrust differs for each material used in housing (3) and end connector element (5).

D. Exemplary End Connector Element with Connector Flange

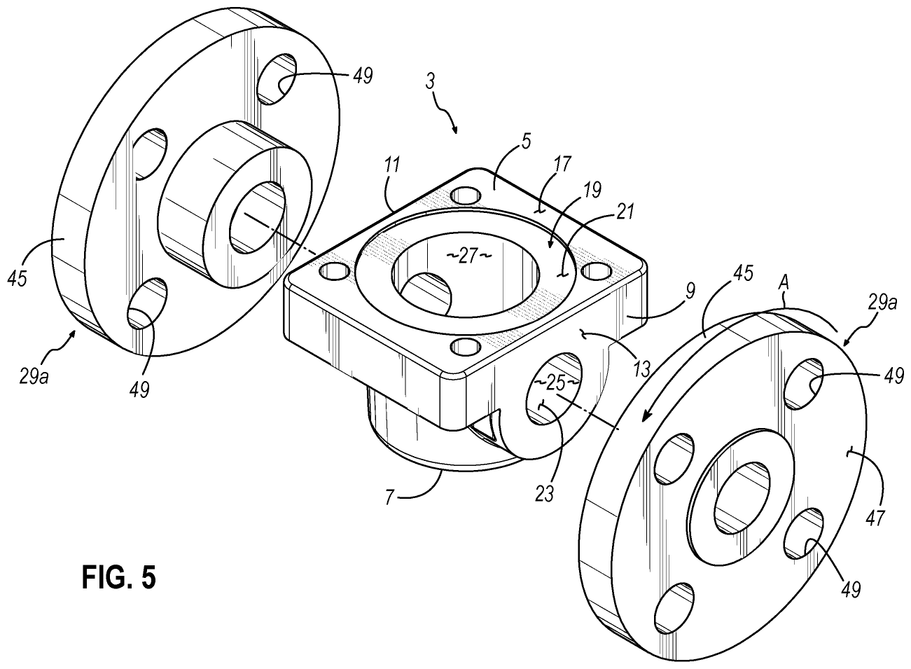

As shown in FIG. 5, modular valve body (1) may include an end connector element (29A) having generally the same features as end connector element (29) and may also be forged, cast, or bar stock machined. However, end connector (29A) further includes a connector flange (45) extending outwardly away from peripheral surface (35). Connector flange (45) includes an outward surface (47) for abutting with a similar flange on a pipeline (not shown). Connector flange (45) defines a plurality of connector apertures (49) extending from outward surface (47) through connector flange (45). Connector apertures (49) are sized and positioned to receive a bolt or similar connector or fastener (not shown) therethrough. The connector may be passed through a similar connector flange on the pipeline to connect the pipeline to end connector element (29A). Inasmuch as connector flange (45) provides for a larger diameter within the overall structure of end connector element (29A), the RPMs and lateral forces required to create friction weld (43) may be adjusted.

E. Modularity of Valve Body

As shown above with respect to housing (3), end connector element (29), and end connector element (29A), modular valve body (1) includes features which allow a user or manufacturer to create multiple housing styles along with multiple end connector element styles. For example, several housing elements may be produced using different methods, one forged, one cast, one bar stock machined. Each particular housing may be more suitable for a particular underlying environment or customer need. In another example, the material used to form several different housing elements may be different, with each material being more suitable for a particular environment. End connector elements may include the same variety. The user may thereafter select and combine a particular housing style with a particular end connector element style as needed for a particular environment or specification. For example, for a given pipeline architecture, the user may select housing (3) along with end connector element (29A) and combine these two elements to form a particular modular valve body (1) well suited for the underlying pipeline or environment. The user may even build modular valve body (1) on demand at the time of receiving a purchase order.

In another example, many different versions of housing (3) having the same overall profile may be formed, but using different materials. Similarly, many different versions of end connector element (29) having the same overall profile may be formed, but using different materials. Thereafter, depending on the needs of the purchaser or environment, the user may select housing (3) and/or end connector (29) formed from materials having a certain desirable property and form modular valve body (1) therefrom.

The modularity of modular valve body (1) allows a user to “mix and match” components such as housing (3) and end connector element (29) based on a particular shape and/or material composition which is beneficial to the underlying use or need.

II. Exemplary Methods of Forming A Modular Valve Body

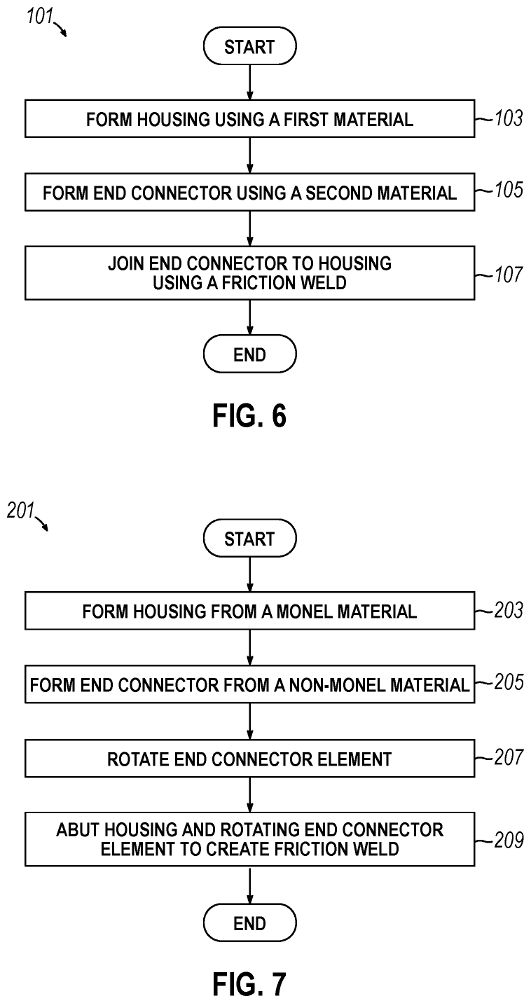

An exemplary method of forming a modular valve body with bimetallic option (101) is depicted as a flowchart in FIG. 6. Method (101) begins with a step (103), whereby a housing is formed using a first material. The housing may be formed by forging, casting, or bar stock machining. Thereafter, step (103) proceeds to a step (105). In step (105), an end connector element is formed using a second material. The end connector may be formed by forging, casting, or bar stock machining. Thereafter, step (105) proceeds to a step (107). In step (107), the end connector element is joined to the housing using a friction weld. Thereafter, method (101) proceeds to end. The first material and second material may be similar materials or may be different materials.

An exemplary method of forming a modular valve body with bimetallic option (201) is depicted as a flowchart in FIG. 7. Method (201) begins with a step (203), whereby a housing is formed from a monel material. The housing may be formed by forging, casting, or bar stock machining. Thereafter, step (203) proceeds to a step (205). In step (205), an end connector element is formed from a non-monel material. The end connector may be formed by forging, casting, or bar stock machining. Thereafter, step (205) proceeds to a step (207). In step (207), the end connector element is rotated. Thereafter, step (207) proceeds to a step (209). In step (209), the rotating end connector element abuts the housing to create a friction weld between the housing and the end connector element. Thereafter, method (201) proceeds to end.

III. Exemplary Combinations

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### EXAMPLE 1

A modular valve body comprising: (a) a housing, wherein the housing is formed from a first material; and (b) an end connector element, wherein the end connector element is formed from a second material, wherein the end connector element is frictionally welded to the housing.

### EXAMPLE 2

The modular valve body or method of the previous or subsequent Examples, wherein the end connector element is rotationally frictionally welded to the housing.

### EXAMPLE 3

The modular valve body or method of any of the previous or subsequent Examples, wherein the first material is a nickel alloy, wherein the second material is carbon steel.

### EXAMPLE 4

The modular valve body or method of any of the previous or subsequent Examples, wherein the nickel alloy is monel.

### EXAMPLE 5

The modular valve body or method of any of the previous or subsequent Examples, wherein the housing is forged, wherein the end connector element is forged.

### EXAMPLE 6

The modular valve body or method of any of the previous or subsequent Examples, wherein the housing is cast, wherein the end connector element is cast.

### EXAMPLE 7

The modular valve body or method of any of the previous or subsequent Examples, the housing comprising an internal housing surface, wherein the internal housing surface defines a housing flow passage through the housing, wherein the internal housing surface is smooth along the entire housing flow passage.

### EXAMPLE 8

The modular valve body or method of any of the previous or subsequent Examples, the end connector element comprising an internal end surface, wherein the internal end surface defines an end flow passage through the end connector element, wherein the end surface is smooth along the entire end flow passage.

### EXAMPLE 9

A method of forming a modular valve body, the method comprising: (a) forming a housing using a first material; (b) forming an end connector element using a second material; and (c) joining the end connector element to the housing using a friction weld.

### EXAMPLE 10

The modular valve body or method of any of the previous or subsequent Examples, further comprising: (a) holding the housing in a static position; (b) rotating the end connector element; and (c) pressing the rotating end connector element into the body to create the friction weld.

### EXAMPLE 11

The modular valve body or method of any of the previous or subsequent Examples, wherein the first material is a nickel alloy.

### EXAMPLE 12

The modular valve body or method of any of the previous or subsequent Examples, wherein the nickel alley is monel.

### EXAMPLE 13

The modular valve body or method of any of the previous or subsequent Examples, further comprising forging the first material to form the housing.

### EXAMPLE 14

The modular valve body or method of any of the previous or subsequent Examples, further comprising casting the first material to form the housing.

### EXAMPLE 15

The modular valve body or method of any of the previous or subsequent Examples, wherein the second material is a carbon steel.

### EXAMPLE 16

The modular valve body or method of any of the previous or subsequent Examples, further comprising forging the second material to form the end connector.

### EXAMPLE 17

The modular valve body or method of any of the previous or subsequent Examples, further comprising casting the second material to form the end connector.

### EXAMPLE 18

A method of forming a modular valve body, the method comprising: (a) forming a housing from a monel material; (b) forming an end connector element from a non-monel material; (c) rotating the end connector element; and (d) abutting the rotating end connector element with the housing to create a friction weld between the housing and the end connector element.

### EXAMPLE 19

The modular valve body or method of any of the previous or subsequent Examples, further comprising: (a) forging the housing with an internal housing surface, wherein the internal housing surface defines a housing flow passage, wherein the internal housing surface is smooth; and (b) forging the end connector element with an internal end surface, wherein the internal end surface defines an end flow passage, wherein the internal end surface is smooth.

### EXAMPLE 20

The modular valve body or method of any of the previous or subsequent Examples, further comprising forming the end connector element with a connector flange.

### EXAMPLE 21

A modular valve body comprising: (a) a housing; and (b) an end connector element, wherein the end connector element is frictionally welded to the housing.

### EXAMPLE 22

The modular valve body or method of any of the previous or subsequent Examples, wherein the end connector element is rotationally frictionally welded to the housing.

### EXAMPLE 23

The modular valve body or method of any of the previous or subsequent Examples, wherein one or both of the housing and the end connector is forged.

### EXAMPLE 24

The modular valve body or method of any of the previous or subsequent Examples, wherein one or both of the housing and the end connector is cast.

### EXAMPLE 25

The modular valve body or method of any of the previous or subsequent Examples, the housing comprising an internal housing surface, wherein the internal housing surface defines a housing flow passage through the housing, wherein the internal housing surface is smooth along the entire housing flow passage.

### EXAMPLE 26

The modular valve body or method of any of the previous or subsequent Examples, the end connector element comprising an internal end surface, wherein the internal end surface defines an end flow passage through the end connector element, wherein the end surface is smooth along the entire end flow passage.

### EXAMPLE 27

The modular valve body or method of any of the previous or subsequent Examples, wherein the housing is formed from a first material, wherein the first material is a nickel alloy, wherein the end connector is formed from a second material, wherein the second material is carbon steel.

### EXAMPLE 28

The modular valve body or method of any of the previous or subsequent Examples, wherein the nickel alloy is monel.

### EXAMPLE 29

A method of forming a modular valve body, the method comprising: (a) forming a housing; (b) forming an end connector element; and (c) joining the end connector element to the housing using a friction weld.

### EXAMPLE 30

The modular valve body or method of any of the previous or subsequent Examples, further comprising: (a) holding the housing in a static position; (b) rotating the end connector element; and (c) pressing the rotating end connector element into the body to create the friction weld.

### EXAMPLE 31

The modular valve body or method of any of the previous or subsequent Examples, wherein one or both of the housing and the end connector element are formed by forging.

### EXAMPLE 32

The modular valve body or method of any of the previous or subsequent Examples, wherein one or both of the housing and the end connector element are formed by casting.

### EXAMPLE 33

The modular valve body or method of any of the previous or subsequent Examples, further comprising: (a) forming the housing using a first material; and (b) forming the end connector using a second material.

### EXAMPLE 34

The modular valve body or method of any of the previous or subsequent Examples, wherein the first material is monel.

### EXAMPLE 35

The modular valve body or method of any of the previous or subsequent Examples, wherein the second material is a carbon steel.

### EXAMPLE 36

The modular valve body or method of any of the previous or subsequent Examples, further comprising forging one or both of the first material into the housing and the second material into the end connector.

### EXAMPLE 37

The modular valve body or method of any of the previous or subsequent Examples, further comprising casting one or both of the first material into the housing and the second material into the end connector.

### EXAMPLE 38

A method of forming a modular valve body, the method comprising: (a) forming a housing from a monel material; (b) forming an end connector element from a non-monel material; (c) rotating the end connector element; and (d) abutting the rotating end connector element with the housing to create a friction weld between the housing and the end connector element.

### EXAMPLE 39

The modular valve body or method of any of the previous or subsequent Examples, further comprising (a) forging the housing with an internal housing surface, wherein the internal housing surface defines a housing flow passage, wherein the internal housing surface is smooth; and (b) forging the end connector element with an internal end surface, wherein the internal end surface defines an end flow passage, wherein the internal end surface is smooth.

### EXAMPLE 40

The modular valve body or method of any of the previous or subsequent Examples, further comprising forming the end connector element with a connector flange.

IV. Miscellaneous

It should be understood that any of the examples described herein may include various other features in addition to or in lieu of those described above. By way of example only, any of the examples described herein may also include one or more of the various features disclosed in any of the various references that are incorporated by reference herein.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various versions of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I/We claim:

1. A modular valve body comprising:
(a) a housing; and
(b) an end connector element, wherein the end connector element is frictionally welded to the housing.

2. The modular valve body of claim 1, wherein the end connector element is rotationally frictionally welded to the housing.

3. The modular valve body of claim 1, wherein one or both of the housing and the end connector is forged.

4. The modular valve body of claim 1, wherein one or both of the housing and the end connector is cast.

5. The modular valve body of claim 1, the housing comprising an internal housing surface, wherein the internal housing surface defines a housing flow passage through the housing, wherein the internal housing surface is smooth along the entire housing flow passage.

6. The modular valve body of claim 5, the end connector element comprising an internal end surface, wherein the internal end surface defines an end flow passage through the end connector element, wherein the end surface is smooth along the entire end flow passage. The modular valve body of claim 1, wherein the housing is formed from a first material, wherein the first material is a nickel alloy, wherein the end connector is formed from a second material, wherein the second material is carbon steel.

8. The modular valve body of claim 7, wherein the nickel alloy is monel.

9. A method of forming a modular valve body, the method comprising:
(a) forming a housing;
(b) forming an end connector element; and
(c) joining the end connector element to the housing using a friction weld.

10. The method of claim 9, further comprising:
(a) holding the housing in a static position;
(b) rotating the end connector element; and
(c) pressing the rotating end connector element into the body to create the friction weld.

11. The method of claim 10, wherein one or both of the housing and the end connector element are formed by forging.

12. The method of claim 10, wherein one or both of the housing and the end connector element are formed by casting.

13. The method of claim 10, further comprising:
(a) forming the housing using a first material; and
(b) forming the end connector using a second material.

14. The method of claim 13, wherein the first material is monel.

15. The method of claim 14, wherein the second material is a carbon steel.

16. The method of claim 13, further comprising forging one or both of the first material into the housing and the second material into the end connector.

17. The method of claim 13, further comprising casting one or both of the first material into the housing and the second material into the end connector.

18. A method of forming a modular valve body, the method comprising:
(a) forming a housing from a monel material;
(b) forming an end connector element from a non-monel material;
(c) rotating the end connector element; and
(d) abutting the rotating end connector element with the housing to create a friction weld between the housing and the end connector element.

19. The method of claim 18, further comprising:
(a) forging the housing with an internal housing surface, wherein the internal housing surface defines a housing flow passage, wherein the internal housing surface is smooth; and
(b) forging the end connector element with an internal end surface, wherein the internal end surface defines an end flow passage, wherein the internal end surface is smooth.

20. The method of claim 18, further comprising forming the end connector element with a connector flange.
